(19) United States
(12) Patent Application Publication
(10) Pub. No.: US 2003/0143980 A1
(43) Pub. Date: Jul. 31, 2003

(54) Security apparatus and method for information processing device using an e-mail

(76) Inventors: Sang Baek Choi, Inchon (KR); Young Hun Choi, Seoul (KR)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/257,831

(22) PCT Filed: Apr. 17, 2001
(86) PCT No.: PCT/KR01/00641

(30) Foreign Application Priority Data
Apr. 17, 2000 (KR) 2000/20034

(51) Int. Cl. H04M 1/66

(52) U.S. Cl. 455/411; 455/414

(57) ABSTRACT

The disclosed is a security apparatus and method for information systems adapted to register personal information of a user and system information and to transmit such information regularly to a server, to confirm and the identity and location information of an originating party who accesses to a network using a stolen or lost information system and to control remotely the stolen or lost information systems. These apparatus and method serves to prevent theft or loss of the information systems, to trace and to retrieve such stolen or lost information system and to protect information stored therein.

### TECHNICAL FIELD

The present invention relates generally to a security apparatus and method for information systems, and more particularly to a security apparatus and method for information systems using an E-mail, which is adapted to prevent theft or loss of the information systems and trace and retrieve the stolen or lost information systems by registering personal information of a user and system information, transmitting such information regularly to a server and confirming and processing the identity and location information of an unauthorized user who accesses a network using the stolen or lost information system, and to protect information stored in the information systems through remote control of them.

### BACKGROUND ART

With the advent of the cyber era, it is common to use such information systems as computer, Personal Digital Assistant (PDA), portable telephone, etc.. In particular, the miniaturization and lightness of these information systems due to the development of electronic telecommunication technology promotes the use of portable information systems such as notebook computer, palmtop computer, etc. Such portable information systems are portable, expensive and liquid, and so have a high risk of theft and loss. As a user tends to store a great deal of information in a notebook computer of his own, if it is stolen or lost, a great loss of property, wasted labor due to the rewriting of data files, and a vast inconvenience result from the loss of a simple article.

As measures against theft or loss of such portable information systems as a notebook computer, methods for preventing illegal access to the information stored in the portable information systems and methods for preventing the drain of information to protect information or data in case of theft or loss have been developed and used. For example, the notebook computer, which employs as an option a fingerprint recognization system available from Compaq Korea, Inc., provides effective data security function by the exclusive use of the notebook computer by owner, as it is in effect impossible to duplicate a fingerprint code for presentation to the fingerprint recognization system. However, as the security method by means of a password or the fingerprint recognization at the time of booting the computer serves to protect only the information stored in the portable information system, it does not provide means for tracing and retrieving the portable information system itself when it is stolen or lost. In addition, though notebook computer repair and replacement insurance to compensate the user for a prescribed amount of money when the notebook computer is broken, theft and loss insurance has not yet been offered due to their high risk. Accordingly, there is an urgent need for the development of a method to retrieve the expensive information system itself in case of theft or loss.

### DISCLOSURE OF THE INVENTION

Accordingly, the present invention has been made keeping in mind the above problems occurring in the prior art, and an object of the present invention is to provide a security apparatus and method for information systems using E-mail which is capable of tracing and retrieving the information systems when they are stolen or lost.

Another object of the present invention is to provide a security apparatus and method for information systems using E-mail which is capable of preventing theft of the information systems by making an illegal use and disposal of the information systems by another person impossible.

Still another object of the present invention is to provide a security apparatus and method for information systems using E-mail, which is capable of preventing the accessing of the information from the lost or stolen information systems.

In order to accomplish the above objects, according to a first aspect of the present invention, a security apparatus for information systems using E-mail comprises: a user connection unit including an internet homepage including a user identification information input for providing a user interface, an internet web server, a common gateway interface (CGI) for processing data of a web document, and a user information database (DB); a user interface unit including a security and management unit for information systems for registering personal information of the user and system information and transmitting such information regularly to a server, a CPU, and a network interface; an information system monitor unit for receiving and managing the E-mail including the personal information of the user and system information transmitted regularly from the user; and a remote control unit for controlling remotely the state of operation of the information system such that the use of a stolen or lost information system is prevented.

According to a second aspect of the present invention, in a security apparatus for information systems using E-mail comprising a user connection unit; a user interface unit including a security and management unit, a CPU, and a network interface; an information system monitor unit including a E-mail server and a E-mail DB; and a remote control unit, a method for establishing security of the information systems comprises the steps of: storing and updating the personal information of the user in the security and management unit for information systems; transmitting the personal information and system information to the E-mail server regularly via the Internet; confirming whether new E-mail is received or not by the E-mail address or E-mail server assigned by the user when the information system is stolen or lost; and identifying a transmitting person and tracing an originating place if the E-mail is received in the confirmation step.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a schematic diagram of a security system for information systems using E-mail according the present invention;

FIG. 1B is a schematic diagram of another embodiment for a user interface unit in the system of FIG. 1A;

FIG. 1C is a schematic diagram of still another embodiment for a user interface unit in the system of FIG. 1A;

FIG. 1D is a schematic diagram of further still another embodiment for a user interface unit in the system of FIG. 1A;

FIG. 2 is a diagram showing a detailed configuration of a security and management unit of the information system in the system of FIG. 1A;

FIG. 3 is a diagram showing a detailed configuration of an information system monitor unit in the system of FIG. 1A;

FIG. 4 is a diagram showing a detailed configuration of a remote control data in the security and management unit of the information system of FIG. 2;

FIG. 5 is a diagram showing the data structure of system information examined by a system information examination unit in the system of FIG. 1A;

FIGS. 6A to 6C are flow charts illustrating various examples of information security processes according to the present invention; and

FIG. 7 is a flow chart illustrating in detail the process of the identification and tracing of an originating place of a stolen or lost information system according to the present invention.

### BEST MODE FOR CARRYING OUT THE INVENTION

Reference now should be made to the drawings, in which the same reference numerals are used throughout the different drawings to designate the same or similar components.

Prior to a detailed description of the present invention, the terms used in the specification are defined as follows. However, other technical terms not described in the definition below are to be construed as common meaning understood well by those skilled in the art.

### Definition

Herein, the term “information system” is intended to include a computer (including a desktop computer, a notebook computer, a palmtop computer, a personal digital assistant (PDA), a set top box, and a Web TV), a portable communication device (including a cellular phone and a PCS), a general telephone (including a wired telephone, a public telephone, and a company telephone network, etc.), a facsimile, etc., which are capable of access to the internet in a wired or wireless manner.

The term “personal information” means information representing personal attribute of the information system such as a unique personal number, an ID, a password, an E-mail address, etc., of a user of the information system.

The term “system information” means system environment information for the information system in use, such as a user IP, a user server IP, an originating telephone number, a used communication network, etc.

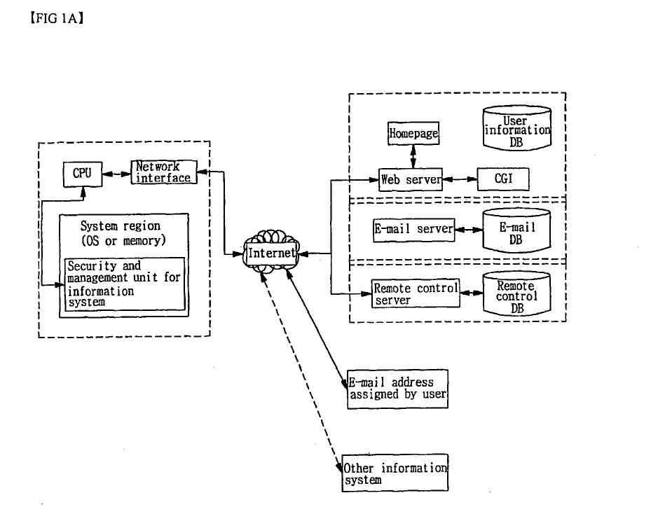

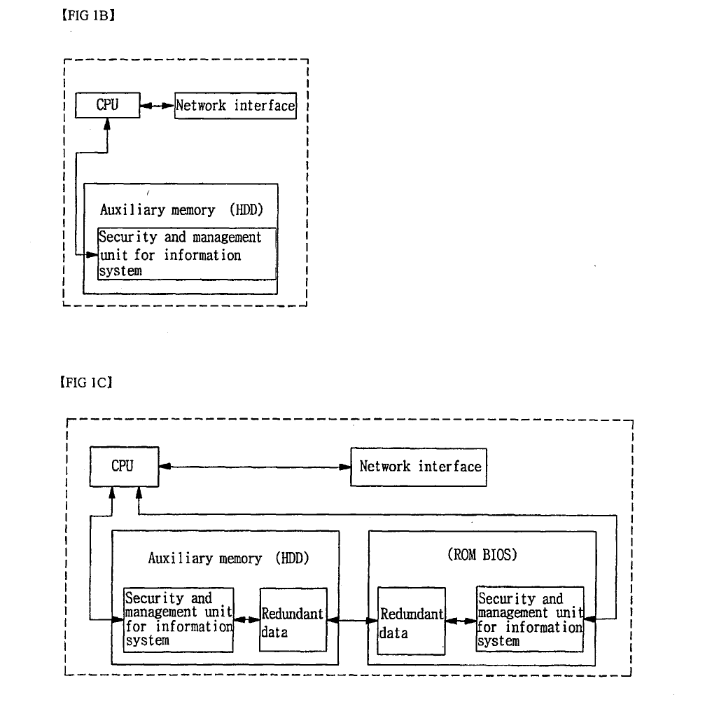

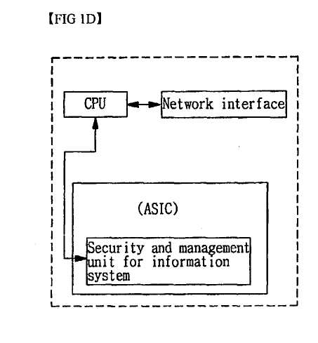

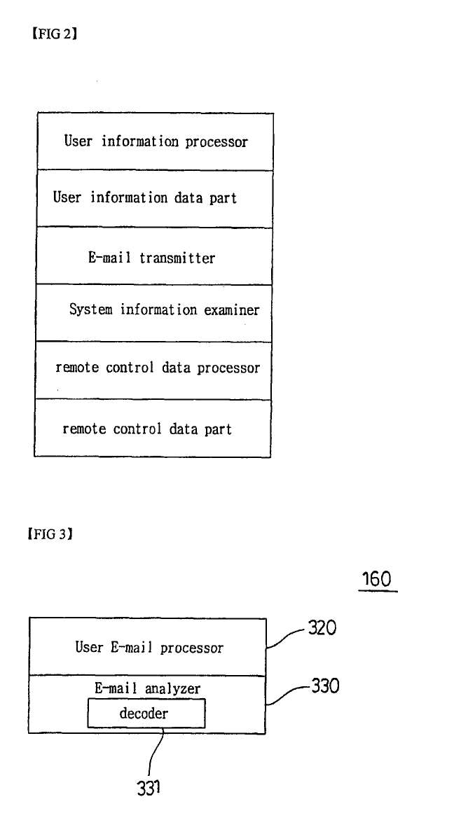

FIG. 1A shows a schematic diagram of a security system for information system using E-mail according to the present invention wherein the security system comprises a user interface unit 110, a user connection unit 150, an information system monitor unit 160, and a remote control unit 170. The user interface unit 110 of the security system comprises a CPU 112, a network interface unit 111, and an information system security and management unit 114, and in addition may include an input device such as a mouse and a keyboard, a display such as a monitor, a RAM, a ROM, etc. The network interface unit 111 is like a modem and connected to an Internet and/or other commercial on-line services for allowing the user of information system to monitor it and report loss or theft of it.

The information security and management unit 114 can be implemented as various embodiments in the present invention. For example, one of the embodiments is implemented by storing the information system security and management unit into an operating system region or a memory region 113 such as a flash ROM, as shown in FIG. 1A, with an application to the information system such as a PDA, a PNA, a Web TV, or a set top box without an auxiliary device like a hard disk.

Another of the embodiments is implemented by storing the function by which data or a program cannot be deleted or cancelled by the user into a hard disk drive (HDD) 123, as shown in FIG. 1B.

Still another of the embodiments, which is applicable to an auxiliary memory 133 such as a hard disk (HDD) and a ROM BIOS 136 as shown in FIG. 1C, is implemented by dualizing 135 and 137 for operating the system even if the ROM BIOS is upgraded or the hard disk is reformatted, such that normal operation of only one of the information system security and management units of the ROM BIOS and HDD makes the recovery of the other possible.

Still another of the embodiments is implemented by designing in a hardware manner the information system security and management unit 144 by means of an ASIC 143 as shown in FIG. 1D. The information system security and management unit 144 in this embodiment is applicable during the design and manufacturing processes of the information system and can be realized in the form of a card to be used in the information system.

As described above, the information system security and management unit of the present invention is included within a system hardware such as a ROM BIOS of the information system and stored into an auxiliary memory such as a hard disk (HDD) by use of a security process such that it is impossible for another person who picks up the information system or a robber to delete the security and management unit from the information system or stop the operation of it. In addition, programs stored in the ROM BIOS and the auxiliary memory operate in a dual mode (master and slave) such that as long as only one of two programs operates normally, the security function of the present invention is well performed and the other program which does not operate normally can be restored to its normal state.

A homepage 151 of the user connection unit 150 in the present invention is the homepage for providing security service of the information system and includes a user identification information input for inputting member registration of a new user and an ID and password of the user if he is an existing member. The web server 152 displays the homepage 151 via a server host at the time of accessing the internet, receives the user identification information via the user identification information input and outputs it, and receives data necessary to the information system security and management and the remote control from the information system monitor unit 160 and the remote control unit 170 and outputs it to be displayed on the screen of the homepage. The common gateway interface (CGI) 153 receives the user identification information from the web server 152 to read out and process user information corresponding to the user from the user information DB 154. The user information DB 154 stores and manages information on the user who wishes to access the Internet.

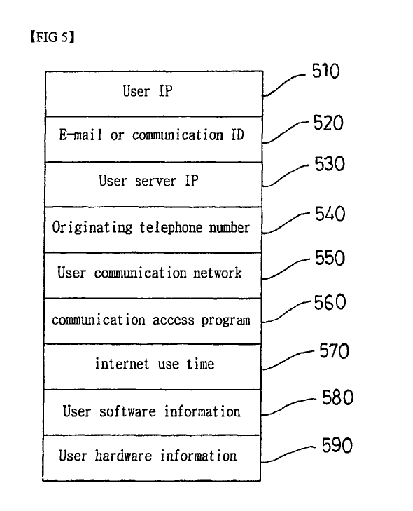

The information system monitor unit 160 in the information system security apparatus of the present invention comprises an E-mail server 161 including user E-mail data and an E-mail DB 162 to manage E-mail data for receiving and managing E-mail transmitted regularly by the user of the information system. The E-mail server 161 includes an E- mail processor 320 to manage the received E-mail and inquire the E-mail if necessary and a user E-mail analyzer 330 to analyze the information of the user of the information system from the received E-mail, using an IP, an ID, an originating telephone number, etc., such that position information of an unauthorized user can be easily known, as shown in FIG. 3. A decoder 331 in FIG. 3 decodes the coded E-mail.

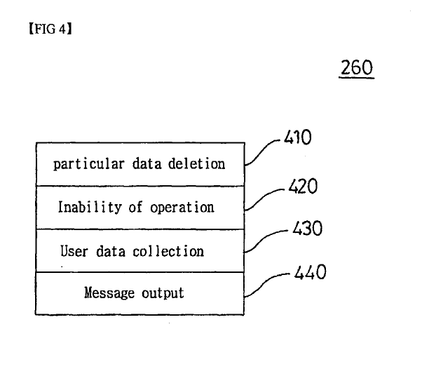

The remote control unit 170 comprises a remote control server 171 including data, e.g., a remote control code, necessary to remote control and a remote control DB 172 to manage remote control data such that the owner (user) of the information system can remotely control the information system. The remote control server 171 receives and processes requests for remote control from the user and inquires processing of remote control code of the remote control processor (250 in FIG. 2) of the information system security and management unit 114.

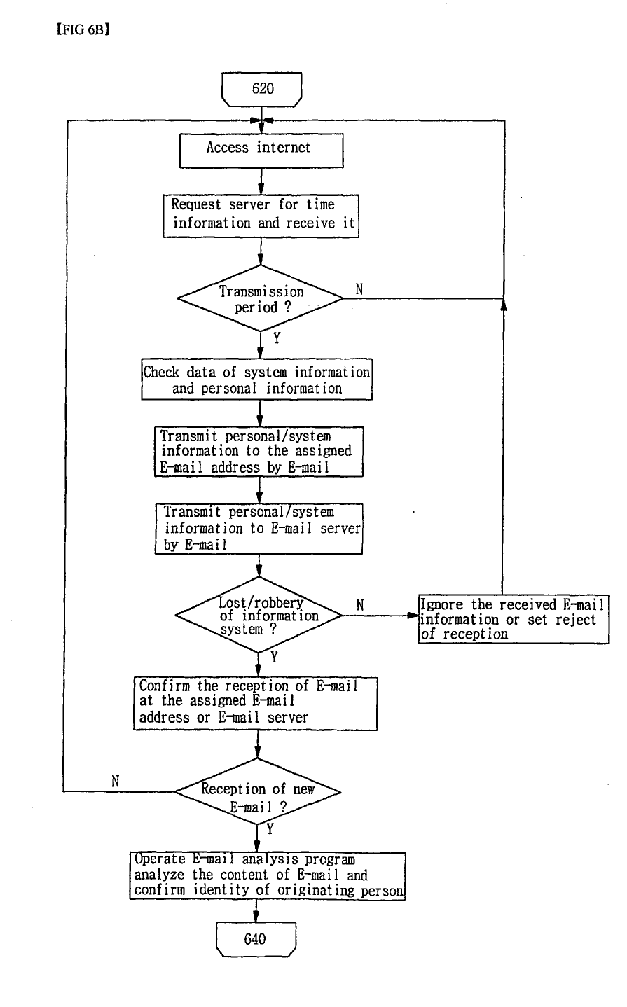

Now, the information system security and management unit 114, 124, 134, 138, and 144 will be described in detail with reference to FIG. 2. The information system security and management unit includes a user information processor 210, a user information data part 220, an E-mail transmitter 230, a system information examiner 240, a remote control processor 250, and a remote control data part 260. The information processor 210 performs input, inquiry, and modification of the user information, stores personal information in the user information data part 220, and transmits the personal information to the user connection unit 150 via the Internet to store it the user information DB 154. The user information data part 220 stores the information such as a unique personal number (e.g., resident registration number), an ID, a password, an E-mail address, etc., used to represent personal attributes of the information system. The E-mail transmitter 230 transmits the E-mail composed of the personal information and system information to the E-mail address 180 and the E-mail server 161 assigned by the user. The system information examiner 240 examines the information, composed of communication related information, hardware and software information, necessary to the transmission of E-mail. Specifically, as shown in FIG. 5, information able to be examined includes user IP 510, E-mail or communication ID 520, user server IP 530, originating telephone number 540, communication network in use 550, communication connection program 560, internet use time 570, used software information 580, used hardware information 590, etc. The communication related information 510 to 570 is used to analyze the position of a user and is composed of the information used to authorize the use of the information system.

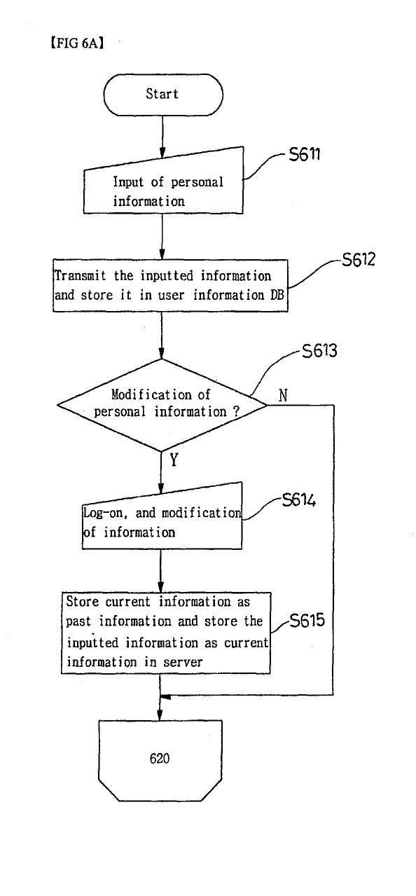

The remote control processor 250 processes remote control according to the remote control code received by the remote control server 171 of the remote control unit 170. The remote control data part 260 processes data necessary to remote control. FIG. 4 shows a detailed diagram of the remote control data part 260. Particular data deletion 410 is used to delete particular data for protection of information. Inability of operation 420 is to make operation of the information system impossible by means of format of hard disk as measures for protection of information. User data collection 430 is to reserve use history of the user of the information system and transmit it to the remote control server 171. Message output unit 440 informs the owner of the information system of the loss or theft of it regularly through voice or character message (e.g., “This computer is a stolen computer. Please notify the police or contact the owner”) when Internet is accessed by the lost or stolen information system, and guides contact point of the owner, so that the lost or stolen information system can be recovered.

The remote control function of the information system of the present invention can stop or restart an established remote control operation depending on the intention of the user.

Now, operation of the security system for the information system is hereafter described. The security system for the information system of the present invention provides the function of preventing illegal-access by a person other than an authorized user from reading or deleting the information stored in the information system. This function is implemented primarily by setting of a unique number. For registration, a user inputs personal information such as E-mail address, resident registration number, name, etc., through operation of the information processor 210 of the information system security and management unit and can inquire or modify the inputted information only through a security procedure. The personal information is stored in the user information data part 220 of the information system security and management unit and transmitted to the user information DB 154 of the user connection unit 150 for storage. At this time, the transmission route is established from CPU 112, 122, 132 and 142 of the information system to the Internet through network interface 111, 121, 131, and 141. By doing so, security of personal information is maintained and preservation of data history can be used as data for a dispute resolution process. In addition, the owner of the information system can be confirmed through verification of the inputted information.

The E-mail transmitter 230 of the information system security and management unit in the present invention automatically transmits E-mail at constant transmission intervals. The transmission period is calculated with accuracy by use of the clock of the server of the present invention or the clock of the Internet server. This prevents E-mail of the user from not being transmitted through the network when an unauthorized person modifies the time arbitrarily such that transmission period of E-mail does not return. The address for reception is the E-mail address 180 assigned by the user and the E-mail server 161 of the present invention. The E-mail transmitted to the E-mail server 161 is stored in the E-mail DB 162. The user may normally ignore E-mail received at the E-mail address or reject reception of E-mail. If the information system is lost or stolen, the user confirms E-mail received at the assigned E-mail address 180 by means of other information system 181 or receives E-mail of the information system monitor unit 160 of the present invention. The E-mail transmitter 230 may code the content of E-mail for transmission, and so, if the code is not known, the content of E-mail will not be opened. The E-mail analyzer 330 reads and analyzes the coded content of E-mail to learn identity of the transmitting person and trace an originating place. The decoder 331 of the E-mail analyzer 330 decodes the coded content of E-mail. Accordingly, the lost or stolen information system can be recovered by tracing of the originating place when the loss or theft is recognized. In addition, analysis result of the content of E-mail can be used as proof of illegal use of the information system.

For the system of the present invention, remote control starts when the user who had the information system lost or stolen accesses the homepage to request the remote control server 171 to begin a remote control. The remote control server 171 sends the remote control code to the originating place. The code is a symbol or character encrypting remote control instructions. When the remote control processor 250 of the information system security and management unit receives the remote control code, it performs processing according to the content of code. For example, function for deleting particular data and function for disabling of operation can be controlled remotely to make the use of data within the lost or stolen information system impossible, and the message displaying the loss or theft continues to be transmitted at random intervals to make the use of the information system impossible. Such remote control of the lost or stolen information system can protect the information stored therein and prevent illegal use of the information.

For security method for the information system according to the present invention, at first, personal information is stored in the information system security and management unit and updated if a modification occurs. When the information system is in normal use, personal information and system information are periodically transmitted to the E-mail server. When the information system is lost or stolen, it is confirmed whether a new E-mail is received or not at the E-mail address assigned by the user or the E-mail server. If received, the identity of transmitting person is confirmed and the originating place is traced to retrieve the lost or stolen information system. In addition, according to the method of the present invention, when the user wishes to use remote control, he transmits the content of remote control to the remote control server for request of remote control, and accordingly the remote control server transmits the remote control code to the remote control processor of the user interface unit which performs remote control according to the remote control code received.

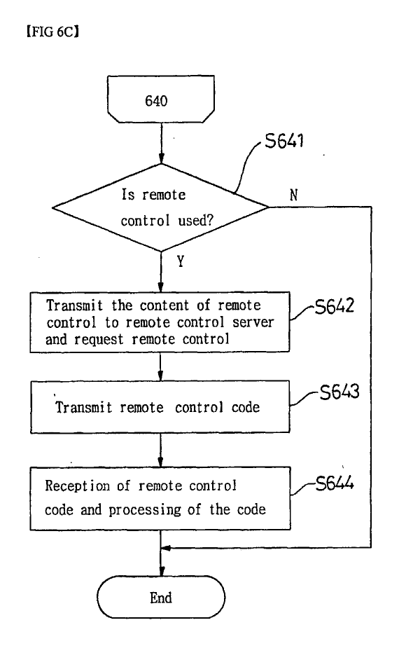

Various embodiments of the security method of the present invention are shown in FIGS. 6A to 6C. For establishment of security, at first, the information system including the information system security and management unit therein is used depending on characteristics of the system, and personal information is inputted by operation of the information processor 210 of the information system security and management unit (S611). The inputted information is stored in the information data part 220 of the information system security and management unit and transmitted to the user connection unit 150 to be stored in the user information DB (S612). If the inputted information is to be modified (S613), it is modified after log-on by operating the user information processor 210 of the information system security and management unit (S614). The modified personal information is stored in the user information data part 220 and transmitted to the user connection unit 150. The server changes current information into past information and manages the modified information to be current information (S615).

Subsequently, referring to FIG. 6B, after the Internet is accessed (S621), time information is received from the server by request (S622). The E-mail transmission period is calculated based on the received time information to confirm the transmission period, and, if the transmission period elapses (S623), the system information data and the personal information are checked (S624). The check of the system information data is that the system information examiner 240 of the information system security and management unit examines the content shown in FIG. 5. After the check, the personal information and the system information are transmitted to the E-mail address 180 assigned by the user (S625). In addition, this information is also transmitted to the E-mail data part 160 (626). If the transmission period has not elapsed, the process returns to Step S621. It is determined if the information system is lost or stolen (S627). If the information system is in normal use without occurrence of loss or theft, E-mail received is ignored or rejection of reception is set (S628). If the loss or theft of the information system occurs, it is confirmed whether a new E-mail is received or not at the E-mail address assigned to other information system 181 by the user or the E-mail server of the present invention (S629). If the new E-mail is not received (S630), the process returns to Step S621. If the new E-mail is received, the E-mail analyzer 330 confirms the content of E-mail and the identity of the originating person (S631). The information on the originating person such as user IP, user communication ID, originating telephone number, etc., is obtained through the analysis of the E-mail. The information on the originating person so obtained can be used to retrieve the lost or stolen information system through a prescribed procedure.

On the other hand, referring to FIG. 6C, it is confirmed whether the user wishes to control remotely the information system or not after the completion of trace for the originating person (S641). If desired, the user transmits the content of remote control to the remote control server for remote control (S642). The information necessary to the request of remote control includes the received E-mail, the ID used, the content of remote control, etc. The remote control server transmits the remote control code to the E-mail address known by the analysis of E-mail (S643). The remote control processor of the information system security and management unit receives and processes the remote control code according to the content of code (S644). Two or more contents of remote control can be processed as shown in FIG. 4 provided with illustrated contents. For the present invention, the transmission of E-mail or the reception and processing of remote control code is designed to be performed automatically regardless of the intention of the user of the information system and the security method, particularly a method implemented by a hardware manner, by which the user can not stop the operation of system is used. After processing of the remote control, data for the information system such as server data and E-mail content is collected to retrieve the information system.

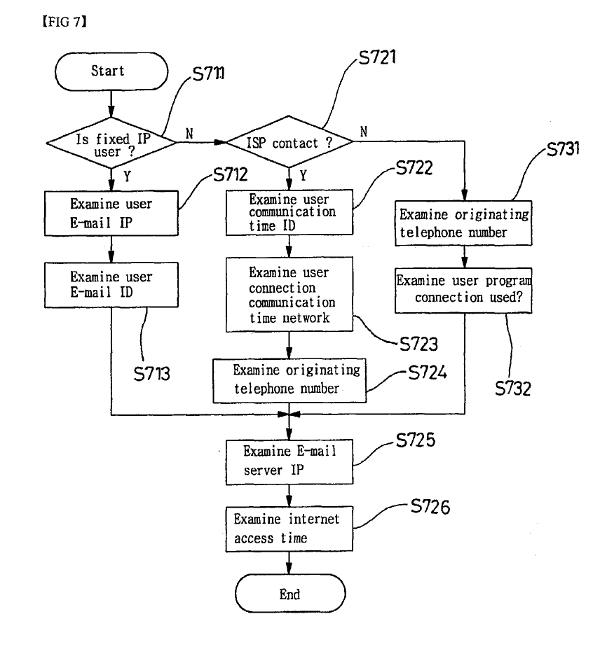

FIG. 7 shows a flow chart of one embodiment for tracing the originating place of the lost or stolen information system according to the security method of the present invention. Specifically, this figure illustrates a flow chart for collecting communication related information of the system information data part 510 to 570 in the transmission content of E-mail of the information system. It is determined whether a fixed IP is used according to current the Internet access method (S711). If so, the user of the fixed IP checks user IP (S712) and then checks user communication ID (S713). Subsequently, it is confirmed if the Internet is accessed through ISP such as Chollian™ or Hitel™ (S721). If the user accessing internet through ISP uses a variable IP, not the fixed IP, then the user communication ID (S722), connection communication network (S723), and originating telephone number (S724) are examined as it is impossible to examine the user IP. If an Internet access program such as one-click program is used without the use of an ISP, the originating telephone number is examined (S731), and then the user access program is examined (S732). In addition, commonly, the user server IP is checked (S725), and then Internet access time is checked (S726).

The security method for the information system of the present invention can further include step of outputting facts of the loss or theft of the information system and contact place of the owner of the system to the screen of the user interface unit when the internet is accessed through the lost or stolen information system. By doing so, theft of the information system can be prevented, and further the stolen information system can be recovered quickly.

### Industrial Applicability

As described above, according to the security apparatus and method for the information system of the present invention, theft of the information system, particularly a potable information system, can be prevented and the owner of the lost or stolen information system can be confirmed. In addition, the lost or stolen information system can be recovered by confirming the location and identity of originating person when the internet is accessed through the lost or stolen information system, and illegal use and drain of the information stored in the lost or stolen information system can be prevented through remote control. Furthermore, the lost or stolen information system can be more easily recovered by transmitting regularly and continually the facts of the loss or theft of the information system and the contact place of the owner by voice or character message through remote control.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A security apparatus for information systems using E-mail, comprising:
a user connection unit including an internet homepage including a user identification information input for providing a user interface, an internet web server, an common gateway interface (CGI) for processing data of a web document, and a user information database (DB);
a user interface unit including a security and management unit for information system for registering personal information of the user and system information and transmitting such information regularly to a server, a CPU, and a network interface;
an information system monitor unit for receiving and managing E-mail including the personal information of the user and system information transmitted regularly from the user; and
a remote control unit for controlling remotely the state of operation of the information system such that the use of a stolen or lost information system is prevented.

2. The apparatus according to claim 1, wherein said security and management unit for information system is stored in a ROM BIOS region of said user interface unit.

3. The apparatus according to claim 1, wherein said security and management unit for information system is stored in an auxiliary memory of said user interface unit.

4. The apparatus according to claim 1, wherein said security and management unit for information system is stored in an operating system region of said user interface unit.

5. The apparatus according to claim 1, wherein said security and management unit for information system comprises an ASIC device.

6. The apparatus according to claim 1, wherein said security and management unit for information system comprises:
a user information processor for processing input, inquiry, and modification of personal information;
a user information data part for storing the personal information;
an E-mail transmitter for transmitting data of the personal information and the system information to a user E-mail address and an E-mail server;
a system information examiner for examining the information necessary to transmission of E-mail;
a remote control processor for processing remote control according to a remote control code received by a remote control server; and
a remote controller for processing data necessary to remote control.

7. In a security apparatus for information systems using E-mail comprising a user connection unit; a user interface unit including a security and management unit, a CPU, and a network interface; an information system monitor unit including a E-mail server and a E-mail DB; and a remote control unit, a method for establishing security of the information systems comprising the steps of:
storing and updating the personal information of the user in said security and management unit for information system;
transmitting the personal information and system information to said E-mail server regularly via the Internet;
confirming whether new E-mail is received or not by the E-mail address or E-mail server assigned by the user when the information system is stolen or lost; and
identifying a transmitting person and tracing an originating place if the E-mail is received in the confirmation step.

8. The method according to claim 7, further comprising the steps of:
transmitting the content of remote control to the remote control server for request of remote control;
transmitting a remote control code from the remote control server to a remote control processor of the user interface unit; and
performing remote control according to the remote control code received by the remote control processor.

9. The method according to claim 7, further comprising the step of outputting facts of the loss or theft of the information system and contact place of the owner of the system to the screen of the user interface unit when the internet is accessed through the lost or stolen information system.
